(19) United States
(12) Patent Application Publication
(10) Pub. No.: US 2017/0192410 A1
(43) Pub. Date: Jul. 6, 2017

(54) MEASUREMENT JIG FOR MEASURING PRECISION ERROR CAUSED BY MULTI-AXIS SYNCHRONIZED MOTION

(71) Applicant: VISION WIDE TECH CO., LTD., Taichung City (TW)

(72) Inventors: Sheng-Hsun HUNG, Taichung City (TW); Sung-Chiang CHEN, Taichung City (TW); Yuan-Long HUNG, Taichung City (TW); Sung-Ta CHAN, Taichung City (TW)

(73) Assignee: VISION WIDE TECH CO., LTD.

(21) Appl. No.: 14/984,550

(22) Filed: Dec. 30, 2015

(51) Int. Cl. G05B 19/401

(52) U.S. Cl. CPC G05B 19/4015; G05B 2219/45209; G05B 2219/37581

(57) ABSTRACT

A measurement jig for measuring precision errors caused by multi-axis synchronized motion is provided and includes: a stand vertically fixed to a table of a machine tool; a first support transversely disposed at an appropriate height of the stand to connect with a first measurement component; a second support vertically disposed on the first support and keeping a distance from the stand to connect with a second measurement component and move relative to the first support; and a third support vertically disposed on the first support between the stand and the second support to connect with a third measurement component and move relatively to the first support, wherein the first, second and third measurement components measure precision errors caused by a multi-axis synchronized motion and examine the precision of the Tool Center Point (TCP).

### BACKGROUND OF THE INVENTION

Technical Field

The present invention relates to measurement jigs and more particularly to a measurement jig for use in measuring precision errors caused by multi-axis synchronized motion of CNC-based numerical control machining tools.

Description of Related Art

Due to technological advances, there is increasingly strong demand for miniaturization and sophisticated parts and components. To meet the demand, multi tasking turning machine and multi-axis machine center are in high demand in recent years, and they keep changing to therefore evolve into measurement apparatuses for use with CNC-based numerical control machining tools. For example, referring to FIG. 1, a magnetic attraction-driven precision error measurement jig 1 comprises a magnetic base 2 magnetically attracted to a table (not shown) of a machine tool. An upright rod 3 is disposed on the magnetic base 2 and pivotally coupled to an adjusting rod 4. The adjusting rod 4 is fastened to an adapter shaft 5 by a set screw T. The adapter shaft 5 is fastened to a fine-tuning unit 6 by another set screw T. The fine-tuning unit 6 is fastened to a measurement gauge 7 by yet another set screw T. The magnetic attraction-driven precision error measurement jig 1 is characterized in that: the set screws T fasten members, namely the adjusting rod 4, the adapter shaft 5, the fine-tuning unit 6 and the measurement gauge 7, in place and are adjustable to thereby change the angles of pivotal swings of the adapter shaft 5 and the fine-tuning unit 6; hence, the measurement gauge 7 measures single-axis precision errors of a test bar (not shown) of a CNC-based numerical control machining tool.

Although the conventional magnetic attraction-driven precision error measurement jig 1 overcomes the limitation of measuring the dynamic performance of a probe by a means of scanning, it has practical drawbacks as follows:

1. The magnetic base 2 of the precision error measurement jig 1 is magnetically attracted to a table of a machine tool, whereas members of the precision error measurement jig 1 are fastened in place by the set screws T, and in consequence the machine tool being measured tends to shake to the detriment of precision.

2. The precision error measurement jig 1 is equipped with one measurement gauge 7 only, and in consequence it measures only one axis in each instance of measurement, thereby rendering the measurement lengthy and inefficient.

3. The precision error measurement jig 1 is designed to work with test bars of the same sizes; as a result, test bars of different sizes require different measurement jigs, respectively.

Accordingly, it is imperative to overcome the aforesaid drawbacks of the prior art.

### SUMMARY

It is an objective of the present invention to provide a measurement jig and test bars which come in different sizes, adapted to measure precision errors caused by a multi-axis synchronized motion, so as to incur low costs but achieve high precision.

In order to achieve the above and other objectives, the present invention provides a measurement jig for measuring precision errors caused by multi-axis synchronized motion, comprising: a stand vertically fixed to a table of a machine tool; a first support transversely disposed at an appropriate height of the stand to connect with a first measurement component; a second support keeping a distance from the stand and vertically disposed on the first support to connect with a second measurement component and move relative to the first support; and a third support disposed between the stand and the second support and vertically disposed on the first support to connect with a third measurement component and move relative to the first support, wherein the first, second and third measurement components measure precision errors caused to the machine tool by a multi-axis synchronized motion and examine the precision of the center of a cutter of the machine tool.

Preferably, the first, second and third measurement components each have a measurement meter and a contact needle, with the contact needles fixed to the first, second and third supports, respectively, through a lock ring each, wherein the contact needles penetrate the first, second and third supports and connect with the measurement meters, respectively.

Preferably, the first support has at least a displacement recess with at least a first fixing hole, wherein the second and third supports each have at least a second fixing hole corresponding in position to the at least a first fixing hole, respectively, with at least a fixing element penetratingly disposed at the first fixing holes and the second fixing holes, respectively, such that the second and third supports move within and get fixed in place within the displacement recess of the first support.

### BRIEF DESCRIPTION OF THE SEVERAL VIEWS OF THE DRAWINGS

Objectives, features, and advantages of the present invention are hereunder illustrated with specific embodiments in conjunction with the accompanying drawings, in which:

FIG. 1 is a perspective view of a conventional measurement jig;

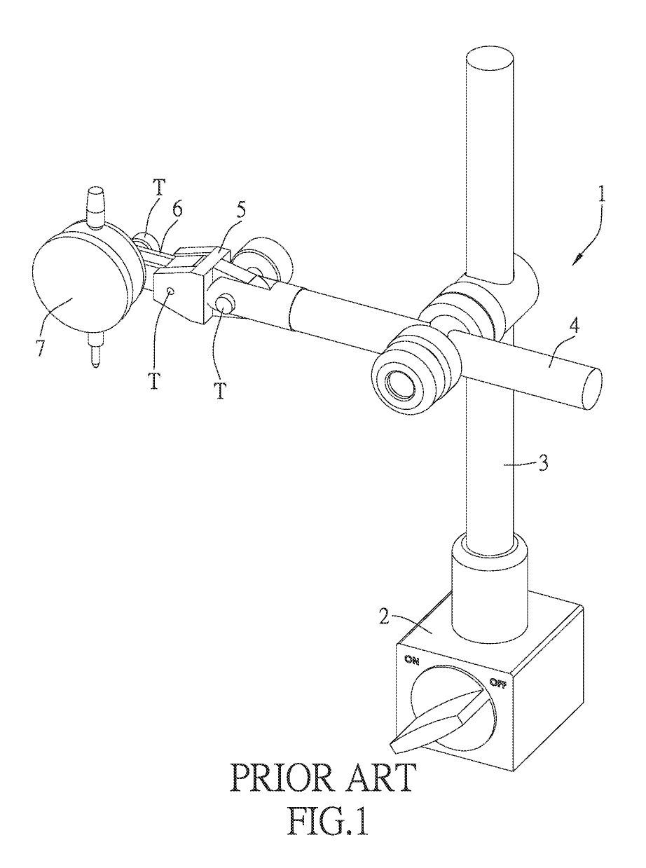

FIG. 2 is an exploded view of a measurement jig of a preferred embodiment of the present invention;

FIG. 3 is a partial perspective view of the measurement jig of the preferred embodiment of the present invention; and

FIG. 4 is a top view which shows how to operate the measurement jig of the preferred embodiment of the present invention.

### DETAILED DESCRIPTION OF THE EMBODIMENT OF THE INVENTION

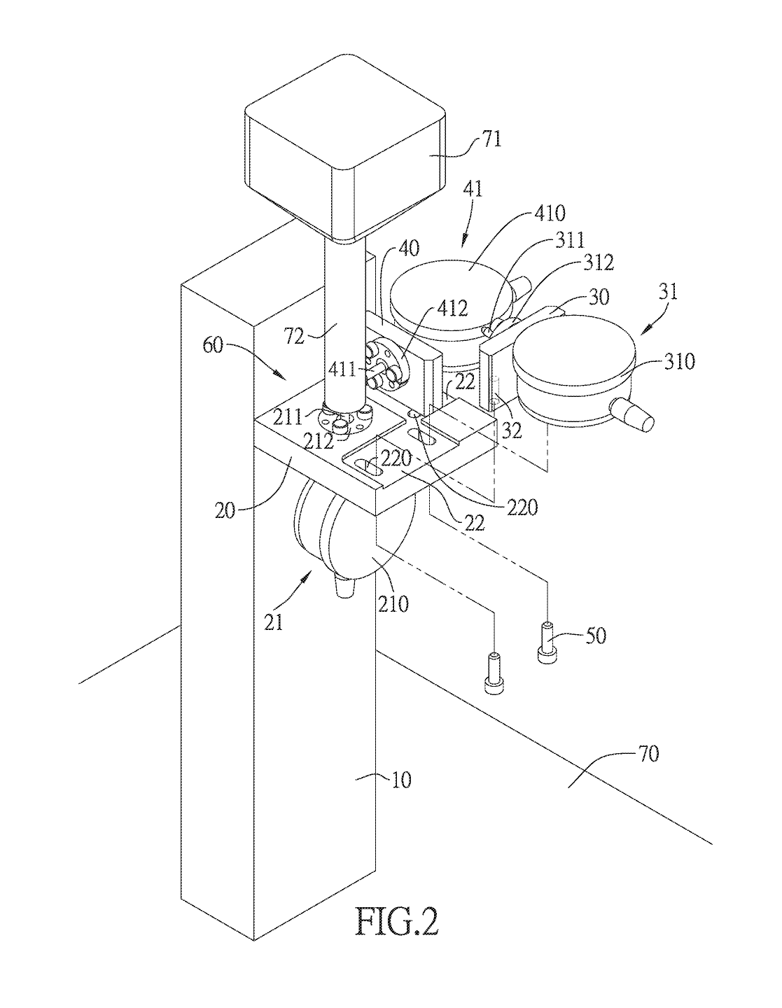

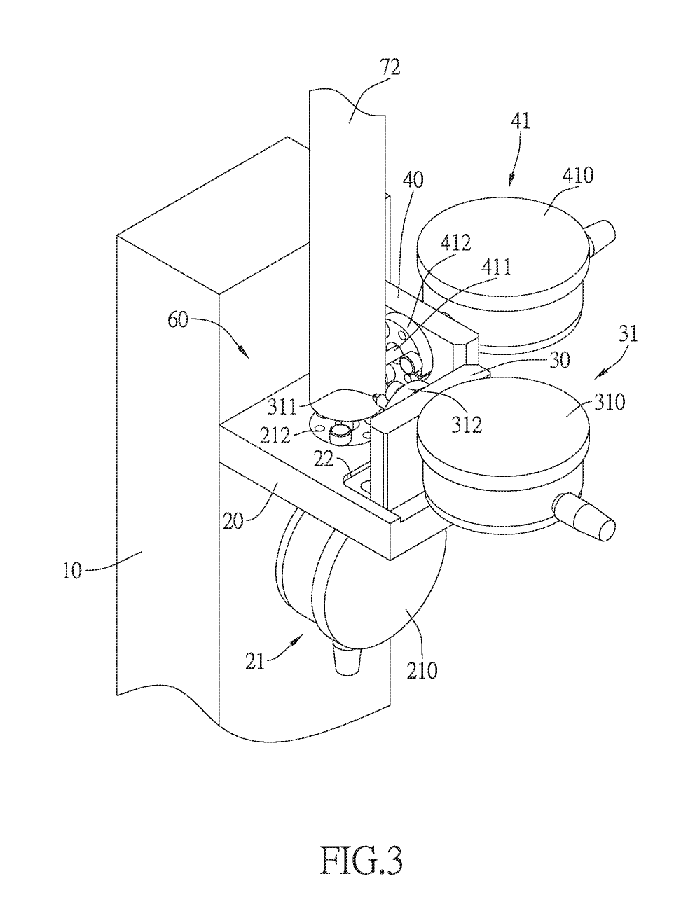

Referring to FIGS. 2-4, in the preferred embodiment of the present invention, a measurement jig for measuring precision errors caused by a multi-axis synchronized motion comprises a stand 10, a first support 20, a second support 30 and a third support 40.

The first support 20 is transversely disposed at an appropriate height of the stand 10. The first support 20 connects with a first measurement component 21. The first measurement component 21 has a measurement meter 210 and a contact needle 211. The contact needle 211 is fixed to the first support 20 through a lock ring 212. The contact needle 211 penetrates the first support 20 and connects with the measurement meter 210.

The second support 30 keeps a distance from the stand 10 and is vertically disposed on the first support 20. The second support 30 connects with a second measurement component 31. The second measurement component 31 has a measurement meter 310 and a contact needle 311. The contact needle 311 is fixed to the second support 30 through a lock ring 312. The contact needle 311 penetrates the first support 30 and connects with the measurement meter 310.

The third support 40 is disposed between the stand 10 and the second support 30 and vertically disposed on the first support 20. The third support 40 connects with a third measurement component 41. The third measurement component 41 has a measurement meter 410 and a contact needle 411. The contact needle 411 is fixed to the second support 40 through a lock ring 412. The contact needle 411 penetrates the first support 40 and connects with the measurement meter 410.

The first support 20 has at least a displacement recess 22 with at least a first fixing hole 220. The second and third supports 30, 40 each have at least a second fixing hole 32 corresponding in position to the at least a first fixing hole 220, respectively. At least a fixing element 50 is penetratingly disposed at the first fixing holes 220 and the second fixing holes 32, respectively; hence, the second and third supports 30, 40 are fixed in place at an appropriate position within the displacement recess 22 of the first support 20. The stand 10 and the first, second and third supports 20, 30, 40 together define a measurement space 60.

Regarding the measurement jig for measuring precision errors caused by a multi-axis synchronized motion according to the preferred embodiment of the present invention, the stand 10 is fixed to and thus mounted on a table 70 of a machine tool. The machine tool further comprises a damper 71. The damper 71 clamps a test bar 72. The test bar 72 is disposed in the measurement space 60 for measuring precision errors precisely and to perform precision correction to the center of a cutter.

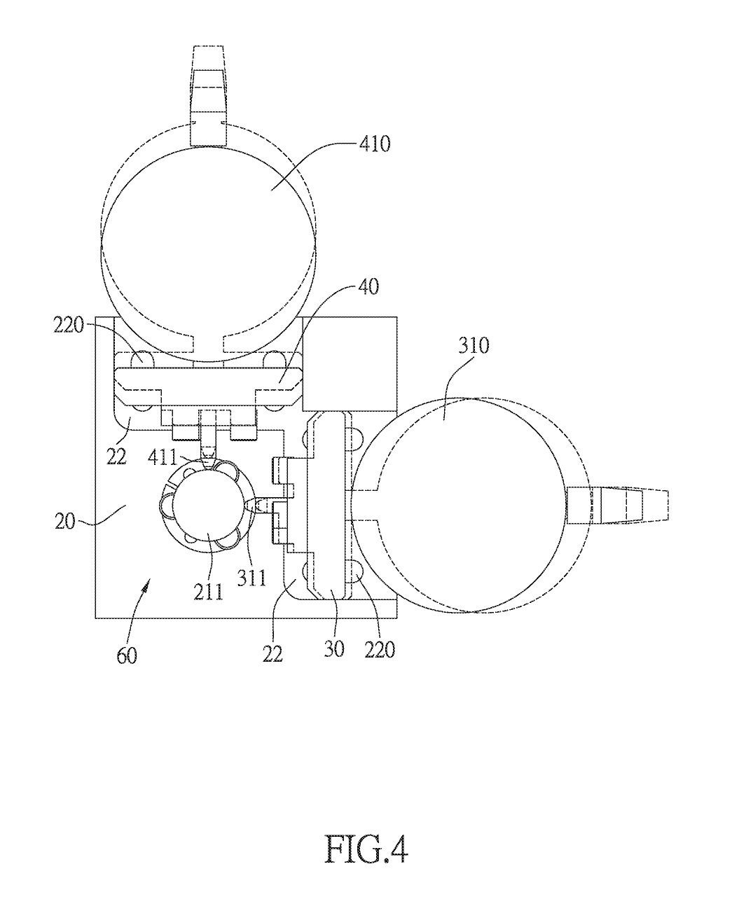

The technical features of the present invention are further described below. The stand 10 is fixed to and thus mounted on the table 70 such that the machine tool being measured is unlikely to shake to the detriment of precision. Referring to FIGS. 2, 4, loosening the at least a fixing element 50 otherwise fastened to the first fixing holes 220 and the second fixing holes 32 enables the second and third supports 30, 40 to move within the displacement recess 22 of the first support 20 until the contact needles 311, 411 of the second and third measurement components 31, 41 come into contact with the test bar 72; at this point in time, the at least a fixing element 50 is fastened to the first fixing holes 220 and the second fixing holes 32, respectively. Therefore, the contact needles 211, 311, 411 of the first, second and third measurement components 21, 31, 41 and the test bar 72 together not only measure precision errors caused by multi-axis synchronized motion but also examine the precision of the Tool Center Point(TCP).

Therefore, according to the present invention, the positions of the second and third supports 30, 40 are adjustable to thereby change the size of the measurement space 60. Hence, the test bar 72 disposed in the measurement space 60 can come in different dimensions. The test bar 72 can be replaced with a test bar different from the test bar 72 in dimensions, and the new test bar will still be fit to measure precision errors, by changing the positions of the second and third supports 30, 40 and adjusting the points of contact between the test bar 72 and the contact needles 311, 411. Furthermore, according to the present invention, the measurement jig for measuring precision errors caused by multi-axis synchronized motion is characterized in that the first, second and third measurement components 21, 31, 41 are mounted on the first, second and third supports 20, 30, 40, respectively, to allow the test bar 72 to measure precision errors caused by multi-axis synchronized motion and presented in three axes (such as x-axis, y-axis and z-axis), thereby enhancing measurement efficiency greatly.

The present invention is disclosed above by preferred embodiments and drawings. However, the preferred embodiments should not be interpreted as restrictive of the scope of the present invention. Hence, all equivalent variations and modifications made to the aforesaid embodiments should fall within the scope of the claims of the present invention.

What is claimed is:

1. A measurement jig for measuring precision errors caused by a multi-axis synchronized motion, which is mounted on a table of a machine tool, comprising:
a stand vertically fixed to the table;
a first support transversely disposed at an appropriate height of the stand to connect with a first measurement component;
a second support vertically disposed on the first support and keeping a distance from the stand to connect with a second measurement component, wherein the second support is movable relative to the first support; and
a third support vertically disposed on the first support between the stand and the second support to connect with a third measurement component, wherein the second support and move is movable relative to the first support;
wherein the first, second, and third measurement components measure precision errors caused by a multi-axis synchronized motion.

2. The measurement jig according to claim 1, wherein the first, second and third measurement components each have a measurement meter and a contact needle, with the contact needles fixed to the first, second and third supports, respectively, through a lock ring each, wherein the contact needles penetrate the first, second and third supports and connect with the measurement meters, respectively.

3. The measurement jig according to claim 1, wherein the machine tool further comprises a damper for clamping a test bar disposed in a measurement space.

4. The measurement jig according to claim 1, wherein the first support has at least a displacement recess with at least a first fixing hole, wherein the second and third supports each has at least a second fixing hole corresponding in position to the at least a first fixing hole, respectively, with at least a fixing element penetratingly disposed at the first fixing holes and the second fixing holes, respectively, such that the second and third supports move within and get fixed in place within the displacement recess of the first support.
